(19) United States
(12) Patent Application Publication
(10) Pub. No.: US 2013/0156436 A1
(43) Pub. Date: Jun. 20, 2013

(54) TERAHERTZ RECEIVER AND METHOD OF RECEIVING TERAHERTZ BAND SIGNAL THEREOF

(71) Applicants: Sungil KIM, Daejeon (KR); Taeyong KIM, Daejeon (KR); Min Hwan KWAK, Daejeon (KR); Seungbeom KANG, Chungcheongbuk-do (KR); Kwang-Yong KANG, Daejeon (KR)

(72) Inventors: Sungil KIM, Daejeon (KR); Taeyong KIM, Daejeon (KR); Min Hwan KWAK, Daejeon (KR); Seungbeom KANG, Chungcheongbuk-do (KR); Kwang-Yong KANG, Daejeon (KR)

(73) Assignee: ELECTRONICS AND TELECOMMUNICATIONS RESEARCH INSTITUTE, Daejeon (KR)

(21) Appl. No.: 13/608,731

(22) Filed: Sep. 10, 2012

(30) Foreign Application Priority Data
Dec. 15, 2011 (KR) 10-2011-0135221

(51) Int. Cl. H04B 10/02

(52) U.S. Cl. 398/115

(57) ABSTRACT

The inventive concept relates to a terahertz receiver. The terahertz receiver of the inventive concept includes a plurality of terahertz detectors detecting signals of terahertz band from received signals; a plurality of optical signal processing parts converting the detected terahertz signals into optical signals; an optical combiner combining the converted optical signals into one optical signal; a photodiode converting the combined optical signal into an electrical signal; and an amplifier amplifying the electrical signal.

### CROSS-REFERENCE TO RELATED APPLICATIONS

This U.S. non-provisional patent application claims priority under 35 U.S.C. §119 of Korean Patent Application No. 10-2011-0135221, filed on Dec. 15, 2011, the entire contents of which are hereby incorporated by reference.

### BACKGROUND

The present inventive concept herein relates to wireless transmission systems, and more particularly, to a terahertz receiver receiving a terahertz band signal and a method of receiving a terahertz band signal thereof.

A wireless transmission system using a terahertz band signal includes a terahertz transmitter transmitting a terahertz band signal and a terahertz receiver receiving a terahertz band signal. The terahertz band signal has a strong directivity and may be attenuated due to humidity in air. To receive a signal using a terahertz band signal, the terahertz receiver is required to be accurately aligned with a terahertz transmitter. The terahertz receiver has a problem that a receiving sensitivity is deteriorated due to a misalignment with the transmitter.

### SUMMARY

Embodiments of the inventive concept provide a terahertz receiver. The terahertz receiver may include a plurality of terahertz detectors detecting signals of terahertz band from received signals; a plurality of optical signal processing parts converting the detected terahertz signals into optical signals; an optical combiner combining the converted optical signals into one optical signal; a photodiode converting the combined optical signal into an electrical signal; and an amplifier amplifying the electrical signal.

### BRIEF DESCRIPTION OF THE FIGURES

Preferred embodiments of the inventive concept will be described below in more detail with reference to the accompanying drawings. The embodiments of the inventive concept may, however, be embodied in different forms and should not be constructed as limited to the embodiments set forth herein. Rather, these embodiments are provided so that this disclosure will be thorough and complete, and will fully convey the scope of the inventive concept to those skilled in the art. Like numbers refer to like elements throughout.

FIG. 1 is a drawing illustrating a terahertz receiver in accordance with some embodiments of the inventive concept.

FIG. 2 is a drawing illustrating an amplifier illustrated in FIG. 1.

FIG. 3 is a drawing illustrating a terahertz receiver in accordance with some other embodiments of the inventive concept.

### DETAILED DESCRIPTION OF THE EMBODIMENTS

Embodiments of inventive concepts will be described more fully hereinafter with reference to the accompanying drawings, in which embodiments of the invention are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

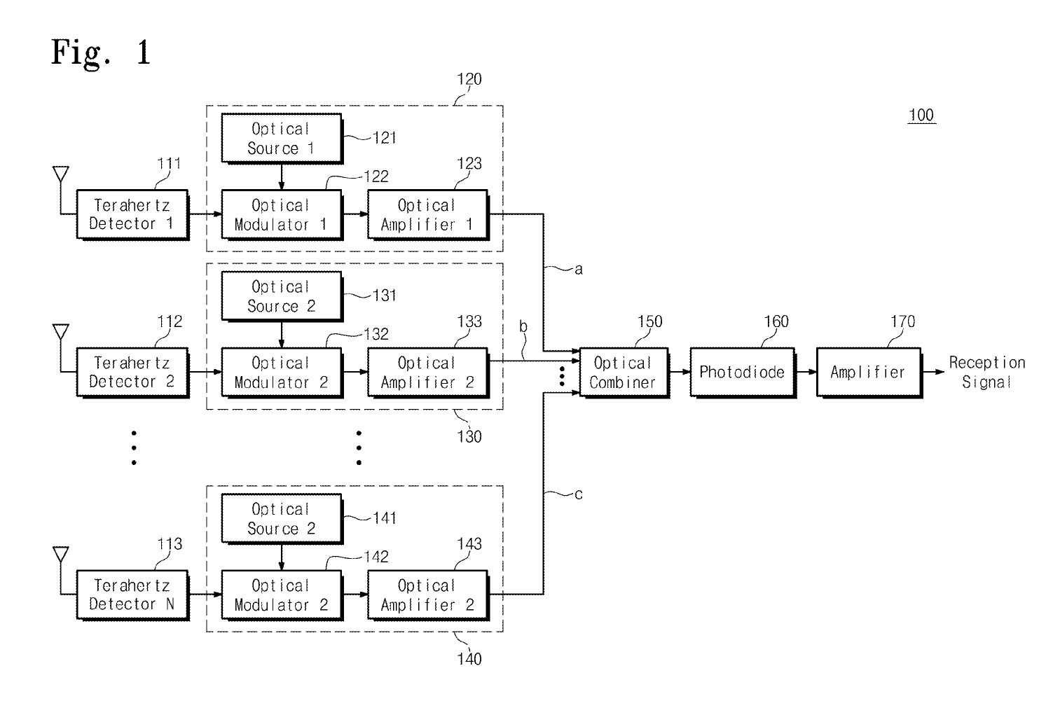

FIG. 1 is a drawing illustrating a terahertz receiver in accordance with some embodiments of the inventive concept.

Referring to FIG. 1, a terahertz receiver 100 includes terahertz detectors 111, 112 and 113, optical signal processors 120, 130 and 140, an optical combiner 150, a photodiode 160 and an amplifier 170.

Each of the first, second and nth terahertz detectors 111, 112 and 113 detects a terahertz signal in terahertz bands. The detected terahertz signal has an envelope shape of terahertz wave. The first, second and nth terahertz detectors 111, 112 and 113 may have an array form. By receiving a terahertz signal using a plurality of terahertz detectors 111, 112 and 113, the terahertz receiver 100 can overcome a misalignment with a transmitter and can improve a receiving sensitivity. That is, the plurality of terahertz detectors 111, 112 and 113 can improve performance of receiving a terahertz band signal. The first, second and nth terahertz detectors 111, 112 and 113 output the detected terahertz signals to the first, second and nth optical signal processors 120, 130 and 140 respectively.

The first optical signal processor 120 converts the terahertz signal detected by the first terahertz receiver 111 into an optical signal. The first optical signal processor 120 includes a first optical source 121, a first optical modulator 122 and a first optical amplifier 123.

The first optical source 121 has a continuous wave optical signal output function for converting an electrical signal into an optical signal for a signal transmission using an optical fiber. The first optical source 121 outputs an optical source for converting an electrical signal into an optical signal to the first optical modulator 122.

The first optical modulator 122 receives a terahertz signal received from the first terahertz detector 111 and an optical source generated from the first optical source 121. The terahertz band signal has an envelope form of terahertz wave. Thus, the first optical modulator 122 modulates an optical source into an envelope form of terahertz wave. The first optical modulator 122 converts an electrical signal in terahertz bands into an optical signal through modulation. The first modulator 122 outputs the modulated optical signal to the first optical amplifier 123.

The first optical amplifier 123 amplifies a modulated optical signal. An erbium-dopped fiber amplifier (EDFA) having high amplification efficiency may be used as the first optical amplifier 123. The first optical amplifier 123 outputs the amplified optical signal to the optical combiner 150.

The second optical processor 130 converts a terahertz signal detected from the second terahertz receiver 112 into an optical signal. The second optical processor 130 outputs the converted optical signal to the optical combiner 150. The second optical processor 130 includes a second optical source 131, a second optical modulator 132 and a second optical amplifier 133.

The nth optical signal processor 140 converts a terahertz signal detected from the nth terahertz receiver 113 into an optical signal. The nth optical processor 140 outputs the converted optical signal to the optical combiner 150. The nth optical processor 140 includes an nth optical source 141, an nth optical modulator 142 and an nth optical amplifier 143.

Since structures and operations of the second and nth optical signal processors 130 and 140 are similar to the structure and the operation of the first optical signal processor 120, the structures and operations of the second and nth optical signal processors 130 and 140 are described with reference to the structure and the operation of the first optical signal processor.

The optical combiner 150 combines optical signals output from the plurality of optical signal processors 120, 130 and 140. A connection between the optical combiner 150 and the optical signal processors 120, 130 and 140 is performed using optical fibers (a, b, c). Each of the optical fibers (a, b, c) may be constituted by a polarization maintaining fiber (PMF) having a low loss rate. The optical combiner 150 can easily match an output phase of reception signal by receiving optical signals generated from the optical signal processors 120, 130 and 140 through the optical fibers (a, b, c) respectively. The optical combiner 150 outputs an optical signal combined into one to the photodiode 160.

The photo diode 160 converts the combined optical signal into an electrical signal. The photodiode 160 outputs the converted electrical signal to the amplifier 170.

The amplifier 170 amplifies the signal converted into an electrical signal. The amplifier 170 outputs the amplified electrical signal to a signal processing part. The signal processing part can restore data included in the reception signal through a signal processing of reception signal.

The terahertz receiver 100 can improve a receiving sensitivity by receiving a terahertz signal using an array structure. The terahertz receiver 100 based on an electrical device using an array structure should be configured that output phases between the terahertz detectors are equal to one another and output signal lines of terahertz detectors have the same length. The terahertz receiver 100 of the inventive concept can easily match an output phase by using an optical fiber through conversion of the detected terahertz signals into an optical signal. Thus, the terahertz receiver 100 of the inventive concept does not need a high degree of design and a high degree of construction technique for a phase match.

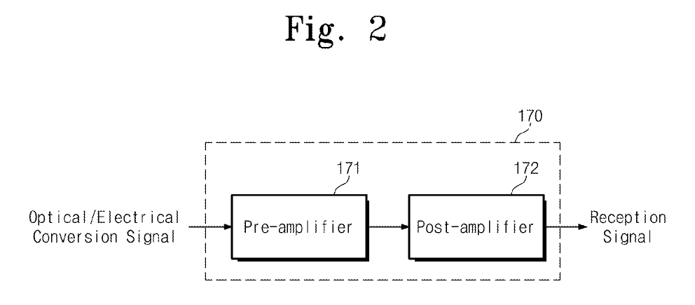

FIG. 2 is a drawing illustrating an amplifier 170 illustrated in FIG. 1.

Referring to FIG. 2, the amplifier 170 includes a pre-amplifier 171 and a post-amplifier 172.

The pre-amplifier 171 amplifies a signal converted into an electrical signal. The preamplifier 170 outputs the amplified signal to the post-amplifier 172.

The post-amplifier 172 amplifies the signal amplified in the pre-amplifier 171 once again and outputs the amplified signal.

To improve a frequency characteristic of reception signal in terahertz bands, the amplifier 170 includes the pre-amplifier 171 and the post-amplifier 172. Thus, the amplifier 170 may include only one amplifier.

A reception operation of the terahertz receiver 100 is as follows.

The terahertz detectors 111, 112 and 113 detect a terahertz signal in terahertz bands from signals received through antennas. The terahertz detectors 111, 112 and 113 output the detected signal in terahertz bands to the optical modulators 122, 132 and 142.

The optical sources 121, 131 and 141 generate optical sources with respect to the terahertz detectors 111, 112 and 113 respectively. The optical sources 121, 131 and 141 output the generated optical sources to the optical modulators 122, 132 and 142.

The optical modulators 122, 132 and 142 modulate the optical sources in an envelope form of terahertz wave corresponding to the received terahertz signal. The optical modulators 122, 132 and 142 generate optical signals through the modulation. That is, each of the optical modulators 122, 132 and 142 converts an electrical signal into an optical signal. The optical modulators 122, 132 and 142 output the generated optical signals to the optical amplifiers 123, 133 and 143 respectively.

Each of the optical amplifiers 123, 133 and 143 amplifies a received optical signal. The optical amplifiers 123, 133 and 143 output the amplified optical signals to the optical combiner 150 through optical fibers (a, b, c).

The optical combiner 150 combines the amplified optical signals with one another. The optical combiner 150 outputs the combined optical signals to the photodiode 160.

The photodiode 160 converts the combined optical signal into an electrical signal. The photodiode 160 outputs the signal converted into an electrical signal to the amplifier 170.

The amplifier 170 amplifies the signal converted into an electrical signal. The amplified signal is output to a signal processor (not shown). The amplifier 170 may amplify an electrical signal by dividing an amplification operation into a pre-amplification operation and a post-amplification operation.

The signal processor processes an amplified signal, that is, a received signal.

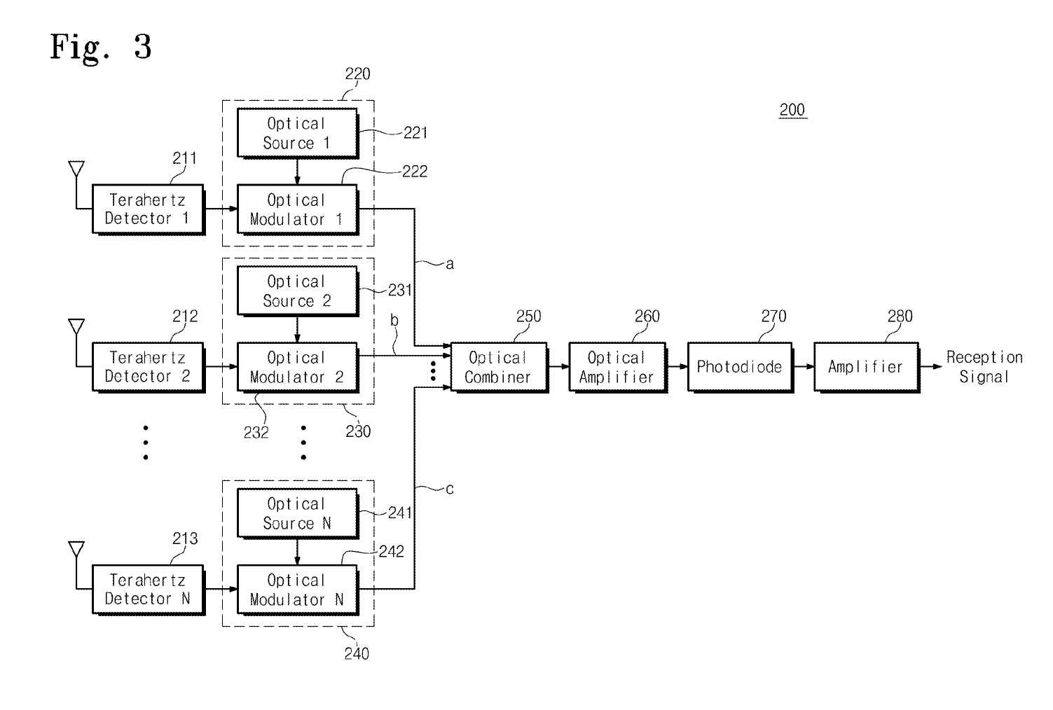

FIG. 3 is a drawing illustrating a terahertz receiver in accordance with some other embodiments of the inventive concept.

Referring to FIG. 3, a terahertz receiver 200 includes terahertz detectors 211, 212 and 213, optical signal processors 220, 230 and 240, an optical combiner 250, an optical amplifier 260, a photodiode 270 and an amplifier 280.

A structure of the terahertz receiver 200 is similar to the structure of the terahertz receiver 100. However, the terahertz receiver 100 of FIG. 1 amplifies an optical signal before the optical combiner while the terahertz receiver 200 amplifies combined optical signal after combining optical signals.

Each of the first, second and nth terahertz detectors 211, 212 and 213 detects a terahertz signal in terahertz bands. The detected terahertz signal has an envelope shape of terahertz wave. The first, second and nth terahertz detectors 211, 212 and 213 may have an array form. By receiving a terahertz signal using a plurality of terahertz detectors 211, 212 and 213, the terahertz receiver 200 can overcome a misalignment with a transmitter and can improve a receiving sensitivity. That is, the plurality of terahertz detectors 211, 212 and 213 can improve performance of receiving a terahertz band signal. The first, second and nth terahertz detectors 211, 212 and 213 output the detected terahertz signals to the first, second and nth optical signal processors 220, 230 and 240 respectively.

The first optical signal processor 220 converts the terahertz signal detected by the first terahertz receiver 111 into an optical signal. The first optical signal processor 220 includes a first optical source 221 and a first optical modulator 222.

The first optical source 221 has a function of outputting a continuous wave optical signal for converting an electrical signal into an optical signal for a signal transmission using an optical fiber.

The first optical source 221 outputs an optical source for converting an electrical signal into an optical signal to the first optical modulator 222.

The first optical source 221 receives a terahertz signal received from the first terahertz detector 211 and an optical source generated from the first optical source 221. The terahertz band signal has an envelope form of terahertz wave. Thus, the first optical modulator 222 modulates an optical source into an envelope form of terahertz wave. The first optical modulator 222 converts an electrical signal in terahertz bands into an optical signal through modulation. The first modulator 222 outputs the modulated optical signal to the optical combiner 250.

The second optical processor 230 converts a terahertz signal detected from the second terahertz receiver 212 into an optical signal. The second optical processor 230 outputs the converted optical signal to the optical combiner 250. The second optical processor 230 includes a second optical source 231 and a second optical modulator 232.

The nth optical signal processor 240 converts a terahertz signal detected from the nth terahertz receiver 213 into an optical signal. The nth optical processor 240 outputs the converted optical signal to the optical combiner 250. The nth optical processor 240 includes an nth optical source 241 and an nth optical modulator 242.

Since structures and operations of the second and nth optical signal processors 230 and 240 are similar to the structure and the operation of the first optical signal processor 220, the structures and operations of the second and nth optical signal processors 230 and 240 are described with reference to the structure and the operation of the first optical signal processor 220.

The optical combiner 250 combines optical signals output from the plurality of optical signal processors 220, 230 and 240. A connection between the optical combiner 250 and the optical signal processors 220, 230 and 240 is performed using optical fibers (a, b, c). Each of the optical fibers (a, b, c) may be constituted by a polarization maintaining fiber (PMF) having a low loss rate. The optical combiner 250 can easily match an output phase of reception signal by receiving optical signals generated from the optical signal processors 220, 230 and 240 through the optical fibers (a, b, c) respectively. The optical combiner 250 outputs an optical signal combined into one to the photodiode 260.

The optical amplifier 260 amplifies the combined optical signal. The optical amplifier 260 outputs the amplified optical signal to the photodiode 270.

The photo diode 270 converts the combined optical signal into an electrical signal. The photodiode 270 outputs the converted electrical signal to the amplifier 170.

The amplifier 280 amplifies the signal converted into an electrical signal. The amplifier 280 outputs the amplified electrical signal to a signal processing part. The signal processing part can restore data included in the reception signal through a signal processing of reception signal.

The amplifier 280 may be constituted by one amplifier and may be constituted by a pre-amplifier and a post-amplifier as illustrated in FIG. 2.

In the terahertz receiver 200, the amplifier 260 amplifying an optical signal is located after the optical combiner 250 while in the terahertz receiver 100, the amplifiers 123, 133 and 143 amplifying optical signals are located before the optical combiner 150. The terahertz receiver 200 can also improve a receiving sensitivity by receiving a terahertz signal using an array structure. The terahertz receiver 200 can easily match an output phase by using an optical fiber through conversion of the detected terahertz signals into an optical signal.

An operation of the terahertz receiver 200 is as follows.

The terahertz detectors 211, 212 and 213 detect terahertz signals of terahertz band from signals received through antennas. The terahertz detectors 211, 212 and 213 output the detected signals of terahertz band to the optical modulators 222, 232 and 242.

The optical sources 221, 231 and 241 generate optical sources with respect to the terahertz detectors 211, 212 and 213 respectively. The optical sources 221, 231 and 241 output the generated optical sources to the optical modulators 222, 232 and 242.

The optical modulators 222, 232 and 242 modulate the optical sources in an envelope form of terahertz wave corresponding to the received terahertz signal. The optical modulators 222, 232 and 242 generate optical signals through the modulation. That is, each of the optical modulators 222, 232 and 242 converts an electrical signal into an optical signal. The optical modulators 222, 232 and 242 output the generated optical signals to the optical amplifiers 223, 233 and 243 respectively through optical fibers (a, b, c).

The optical combiner 250 combines the modulated optical signals with one another. The optical combiner 250 outputs the combined optical signals to the optical amplifier 260.

The optical amplifier 260 amplifies the received optical signal. The optical amplifier 260 outputs the amplified optical signal to the photodiode 270.

The photodiode 270 converts the combined optical signal into an electrical signal. The photodiode 270 outputs the signal converted into an electrical signal to the amplifier 280.

The amplifier 280 amplifies the signal converted into an electrical signal. The amplified signal is output to a signal processor (not shown). The amplifier 280 may amplify an electrical signal by dividing an amplification operation into a pre-amplification operation and a post-amplification operation.

The signal processor processes an amplified signal, that is, a received signal.

The terahertz receivers 100 and 200 are different from each other in a step of amplifying an optical signal. However, the terahertz receivers 100 and 200 can improve signal reception performance by using a plurality of terahertz detectors arrayed to receive a signal in terahertz bands. In the terahertz receivers 100 and 200, signal transmission performance degradation due to signal match does not occur by combining terahertz signals through conversion of electrical signal into optical signal.

The terahertz receiver of the inventive concept may be applied to a terahertz signal reception in a communication system using a signal in terahertz bands or an object recognition system for object recognition.

The terahertz receiver of the inventive concept may have signal reception performance of high sensitivity by combining terahertz signals arrayed through conversion of optical signal into electrical signal. The terahertz receiver of the inventive concept may have improved signal reception performance by detecting a plurality of terahertz signals using terahertz detectors which are arrayed. The terahertz receiver of the inventive concept may minimize phase noise and loss by matching terahertz signals converted from optical signal into electrical signal through optical fibers.

The foregoing is illustrative of the inventive concept and is not to be construed as limiting thereof. Although a few embodiments of the inventive concept have been described, those skilled in the art will readily appreciate that many modifications are possible in the embodiments without materially departing from the novel teachings and advantages of the present invention. Accordingly, all such modifications are intended to be included within the scope of the present invention as defined in the claims. The present invention is defined by the following claims, with equivalents of the claims to be included therein

What is claimed is:

1. A terahertz receiver comprising:
a plurality of terahertz detectors detecting signals of terahertz band from received signals;
a plurality of optical signal processing parts converting the detected terahertz signals into optical signals;
an optical combiner combining the converted optical signals into one optical signal;
a photodiode converting the combined optical signal into an electrical signal; and
an amplifier amplifying the electrical signal.

2. The terahertz receiver of claim 1, wherein the optical signal processing part comprises:
an optical signal generation part generating an optical signal for modulating it into the optical signal; and
an optical modulator receiving the signals of terahertz band and modulating the signal in terahertz bands into an optical signal using the optical signal.

3. The terahertz receiver of claim 2, wherein the optical signal processing part further comprises an optical amplifier amplifying the optical-modulated signal.

4. The terahertz receiver of claim 1, further comprising an optical amplifier amplifying the combined optical signal and outputting the amplified optical signal to the photodiode.
